(19) United States
(12) Patent Application Publication
(10) Pub. No.: US 2002/0166004 A1
(43) Pub. Date: Nov. 7, 2002

(54) Method for implementing soft-DMA (software based direct memory access engine) for multiple processor systems

(76) Inventor: Jason Seung-Min Kim, San Jose, CA (US)

Correspondence Address: GARY CARY WARE & FREIDENRICH LLP, 1755 EMBARCADERO ROAD, PALO ALTO, CA, 94303-3340, US

(21) Appl. No.: 09/847,981

(22) Filed: May 2, 2001

(51) Int. Cl. G06F 13/28

(52) U.S. Cl. 710/22

(57) ABSTRACT

A software-based direct memory access (DMA) engine for a multiple processor system eliminates the overhead and limitations associated with conventional hardware DMA engines. In a preferred embodiment, the DMA engine is implemented in a two processor system that includes separate processor buses and uses a store multiple data locations instruction in combination with a load multiple data locations instruction.

### BACKGROUND OF THE INVENTION

This invention relates generally to a system and method for controlling the access of one or more different computer system resources, such as a microprocessor, a central processing unit or external devices, to a memory and in particular to a novel software-based direct memory access (DMA) engine.

A typical computer system may include a hardware-based direct memory access (DMA) engine that may typically be implemented using an application specific integrated circuit (ASIC). Typically, the DMA engine is attached to the primary computer bus. The DMA engine is designed to manage the access of different resources, such as a central processing unit and various peripheral devices, to a memory. The reason that a DMA engine is used in most computer systems is that the access speed of an external dynamic random access memory (DRAM) is much slower than that of an internal static random access memory (SRAM) that is typically located on the same silicon as the processor. Thus, the DMA may control the transfer of data from the slower DRAM into the faster SRAM because the processor is able to access the data more quickly from the SRAM rather than the DRAM. The DMA may also be used to transfer data from the DRAM or SRAM to one or more peripheral devices, such as a persistent storage device or a modem, that need to access the memory. The DMA engine permits the peripheral devices to directly access the memory without going through the CPU.

Typically, the DMA is connected to the same bus as the processor and the SRAM so that the DMA can use the bus for data transfer when the processor is not using the bus. Thus, most computer systems have a memory bus arbiter that control access to the memory bus so that the processor's data requests do not collide with the DMA's data transfers. Thus, the typical hardware DMA configuration has a significant amount of overhead that is necessary to make the DMA operate properly which is a significant limitation.

In some computer systems that attempt to overcome the DMA overhead problem, some amount of static random access memory (SRAM) is embedded into the core of the processor so that the processor is able to access data directly from the embedded SRAM and the DMA ensures that the proper data is in the processor's SRAM. In this system, the DMA has more access to the memory bus and does not conflict with the processor's need for memory. The problem with this approach is that it does not work very well for a multi-processor system since the SRAM in the particular processor is not readily accessible to the other one or more processors so that access problems occur. These access problems may cause more problems than the problem being solved by the DMA and the embedded SRAM. Thus, although this approach is a good solution for single processor systems, it has the above limitations that makes it inapplicable to multiple processor systems. Thus, it is desirable to provide a software based DMA engine for multiple processor systems and it is to this end that the present invention is directed.

### SUMMARY OF THE INVENTION

The software-based DMA engine in accordance with the invention is particularly applicable to a multiple processor system and it overcomes the limitations and problems associated with typical hardware DMA engines set forth above. The DMA engine may be implemented as one or more data transfer instructions that are executed by one of the multiple processors. The DMA engine thus permits data to be transferred between a DRAM, an SRAM and one or more peripheral devices without the problems associated with a hardware DMA including bus arbitration.

In a preferred embodiment, a two processor system includes the software-based DMA engine. The software-based DMA engine may utilize SIMD (Single Instruction Multiple Data) instructions such as load multiple data instruction (LDM) and a store multiple data instruction (STM) to transfer data between the memories as needed. Since a single instruction may be used to transfer data from multiple locations, the overhead associated with the software-based DMA engine is minimized. The preferred embodiment may also include a bus for each processor, so that each processor may independently access data from the memories as needed.

Thus, in accordance with the invention, a computer system is provided that comprises a first processor, a second processor, and a direct memory access (DMA) engine capable of being executed by one of the first and second processors, the DMA engine capable of transferring data between one or more resources in the computer system.

In accordance with another aspect of the invention, a computer implemented direct memory access apparatus that operates in a computer system having two or more processors is provided. The apparatus comprises a load multiple data instruction capable of being executed by a processor in the computer system for loading data from multiple locations in a resource into multiple locations in an internal register in the processor and a store multiple data instruction capable of being executed by the processor in the computer system for storing data from multiple locations in the internal registers in the processor into multiple locations in a memory.

### BRIEF DESCRIPTION OF THE DRAWINGS

FIG. 1 is a diagram illustrating a typical hardware based DMA engine;

FIG. 2 is a diagram illustrating a multiple processor software based DMA engine in accordance with the invention;

FIG. 3 is a diagram illustrating a preferred embodiment of a multiple processor computer system that includes a software-based DMA engine in accordance with the invention; and

FIG. 4 is a diagram illustrating the preferred operation of a load multiple data and store multiple data instructions that may be used to implement the preferred embodiment of the software based DMA engine in accordance with the invention.

### DETAILED DESCRIPTION OF A PREFERRED EMBODIMENT

The invention is particularly applicable to a dual processor digital music system and it is in this context that the invention will be described. It will be appreciated, however, that the DMA engine in accordance with the invention has greater utility, such as to any other multiple system. To better understand the invention, a conventional hardware based DMA engine will be described along with its limitations that make it inapplicable to a multiple processor system.

FIG. 1 is a diagram illustrating a typical single processor computer system 10 that may include a hardware based DMA engine. In particular, the computer system 10 includes a central processing unit (CPU) 12 that is electrically connected to a primary electrical bus 14. The CPU and the bus 14 are both within a semiconductor chip 15. The chip may also include a direct memory access (DMA) device 16 and an internal memory 18, such as a static random access memory device (SRAM), which are electrically connected to the bus 14. The bus is used to communicate data between the various elements of the computer system as is well known. There may also be one or more input/output buffers 20-24 connected to the bus 14 that interface with one or more peripheral devices off of the chip 15 (Peripheral #1-Peripheral #N) such as a hard disk drive, an audio codec, a liquid crystal display device or the like. In the example shown, the buffers may be first in first out (FIFO) buffers. The bus 14 may also interface with an external memory 26, such as a dynamic random access memory (DRAM), that is located off of the chip. As is well known, the CPU 12 may access data from the SRAM or the DRAM depending on where the data is located. In addition, the peripheral devices may also access data in the SRAM or DRAM. To control the access to the SRAM, the DMA 16 arbitrates the bus 14 to avoid collisions between different memory access requests. In addition, since an access to the external DRAM 26 is as much as four times slower that an access to the SRAM 18, it is desirable for most of the data requested by the CPU 12 to be located in the SRAM. The DMA 16 therefore tries to ensure that the data needed by the CPU is located in the SRAM. In typical systems, the DMA is an application specific integrated circuit (ASIC) that has microcode within in to perform the memory access and arbitration tasks assigned to it.

As shown, the DMA 16 may transfer data over the bus 14 to various locations as shown by the arrows. Since it shares the bus 14 with the CPU 12, the DMA performs transfers only when the CPU is not using the bus. To accomplish this, the DMA must also act as the bus arbiter. Thus, with this conventional computer system, the bus 14 is a bottleneck since both the CPU and DMA must use the same bus to transfer and access data. To alleviate that problem and limitation, some systems embed a static random access memory (SRAM) 28 in the CPU core so that the CPU has its own memory to access data from. For a single processor system shown, the embedded SRAM 28 solves some of the limitations of the hardware DMA engine. However, for a multiple processor system, the embedded SRAM approach does not work well. In particular, if there is an embedded SRAM in each processor core, the hardware costs and overhead associated with the DMA engine grows too large. If there is only an embedded SRAM in one processor core, the second processor may be unable to easily access the SRAM so that the original problem of the bus bottleneck still occurs. To solve these problems and limitations for a multiple processor system, a novel method for implementing software-based DMA engine in accordance with the invention will now be described.

FIG. 2 is a diagram illustrating a multiple processor system 30 including a software based DMA engine in accordance with the invention. The system 30 has many of the same elements shown in FIG. 1 and those elements have the same reference number and are not necessarily described here. In addition to the elements shown in FIG. 1, this system 30 includes a second processor 32 that is connected to a second bus that is then connected to each element that the first bus 14 is connected to. Thus, the first and second processor can each access any of the resource independently over its own bus. To control the access to the resources, a controller 35 may be used. In this system, the second processor 32 may execute a software based DMA engine 34 that performs the same tasks as the hardware based DMA engine 16 shown in FIG. 1.

It might be suggested that the operation of a software based DMA engine would reduce the overall efficiency of the processors 12, 32 since one processor must execute one or more instructions to implement the DMA engine functions. However, it has been determined experimentally that the DMA operations and the execution of the instructions will require approximately 3% of the processing capabilities of the processors. Thus, only 97% of the processor can be used for the other tasks that must be completed by the processors. However, since the hardware DMA 16 and its latency has been removed, the speed of the processors is by about the same 3% so that there is no loss of net processing power. In particular, the traffic cop and signal light functions of the hardware DMA (e.g., the bus arbitration) has been eliminated since the DMA instructions are now being executed within the processors so that the DMA operations occur more rapidly. In other words, the delay associated with the hardware DMA engine arbitration is eliminated which offsets the reduced capacity of the processors due to the software based DMA engine. In addition, the dual processors have sufficient processing capacity to handle the DMA operations without significantly impairing the processing of the other tasks assigned to the processors. Thus, the software DMA engine is possible in a multiple processor environment whereas a single processor environment typically does not have sufficient processing power to implement the DMA engine. In addition, the dual processor bus architecture shown also facilitates the DMA operation in accordance with the invention. Now, a preferred embodiment of a multiple processor computer system that may include the software based DMA engine will be described.

FIG. 3 is a diagram illustrating a preferred embodiment of a multiple processor computer system 60 that includes a software-based DMA engine 61 in accordance with the invention. The system may also include a cross bar multipath memory controller 62 (corresponding generally to buses 14 and 33 in FIG. 2) and a cross bar multipath peripheral controller 64 which are described in more detail in copending patent application Ser. No. 09/XXX,XXX filed on XXXXXXXX and entitled “Cross Bar Multipath Resource Controller System and Method” which is owned by the same assignee as the present invention and which is incorporated herein by reference.

As shown, the multiple processor system 60 may include a host processor 66 which may preferably be a reduced instruction set (RISC) ARM core made by ARM Inc and a coprocessor core 68 that operate in a cooperative manner to complete tasks as described above. In the preferred embodiment, there may also be a hardware accelerator engine 70 as shown. The software DMA engine 34 in this preferred embodiment may be executed by the coprocessor core 68. An example of the pseudo-code that may be executed by the coprocessor core 68 in accordance with the invention to implement the software-based DMA engine in accordance with the invention will be described in more detail below.

As shown, the host processor, the coprocessor and the hardware accelerator engine are all connected to the multipath memory controller 62 and the multipath peripheral controller 64 as shown. To control access to the shared resources connected to the multipath memory controller and the multipath peripheral controller, the system 60 may include a semaphore unit 72 which permits the two processors 66, 68 to communicate with each other and control the access to the shared resources. The details of the semaphore unit is described in more detail in copending U.S. patent application No. XX/XXX,XXX filed on XXXX,XX 2001 titled “XXX”, owned by the same assignee as the present invention and incorporated herein by reference. The semaphore unit permits the processors to negotiate for the access to the shared resources as described above, but then, due to the multipath controllers 62, 64, permits the processors to access the resources over its own bus that is part of the controllers. To control the timing of the controllers 62, 64, a timer/clock 74 is connected to each controller 62, 64.

Both the memory controller 62 and the peripheral controller 64 are then in turn connected to one or more resources that are shared by the processors. For example, the memory controller 62 in this preferred embodiment is connected to a host instruction memory 76 that is typically accessed by the host processor 66, a ping buffer 78 that may be accessed by each processor as needed, a pong buffer 79 that may be accessed by each processor as needed and a coprocessor instruction memory 80 which is typically accessed by the coprocessor 68. Due to a priority scheme and the cross bar architecture, the host processor may always have priority access to its instruction memory 76 and the coprocessor may always have priority access to its instruction memory 80 since the two processors each have separate buses connected to each resource. The memory controller 62 may also be connected to a cache memory 82, which is a well known 4-way 4 kB set associative cache in the preferred embodiment, a flash memory interface 84 for connecting to an external flash memory and an external synchronous dynamic random access memory (SDRAM) interface 86 with the various necessary signals, such as RAS, CAS, WE, OE and CS, to interface to a typical well known SDRAM.

The peripheral multipath controller, which operates in a similar manner to the memory controller in that each processor may access different shared resources simultaneously, may have one or more peripherals connected to it. In the preferred embodiment, the peripheral controller may be connected to a universal serial bus (USB) interface 88 that in turn connects to a USB device or host, a universal asynchronous receiver/transmitter (UART) interface 90 that in turn connects to communication port (COM) hosts, a TAP/embedded ICE controller 92, an EIDE-CD/CF controller 94 to interface to hard disk drives or CD drives, a key matrix controller 96 that connects to a user input keyboard, an audio-codec controller 98 that connects to an audio coder/decoder (codec), an liquid crystal display (LCD) display controller 100 that connects to a LCD display, a smartcard controller 102 for connecting to a well known smart card and an input/output (I/O) expansion port 104 that connects to one or more different input/output devices. As with the memory controller, the peripheral controller provides access for each processor to each shared resource. Now, an example of the DMA engine instructions and an example of pseudocode to implement an audio DMA operation will be described.

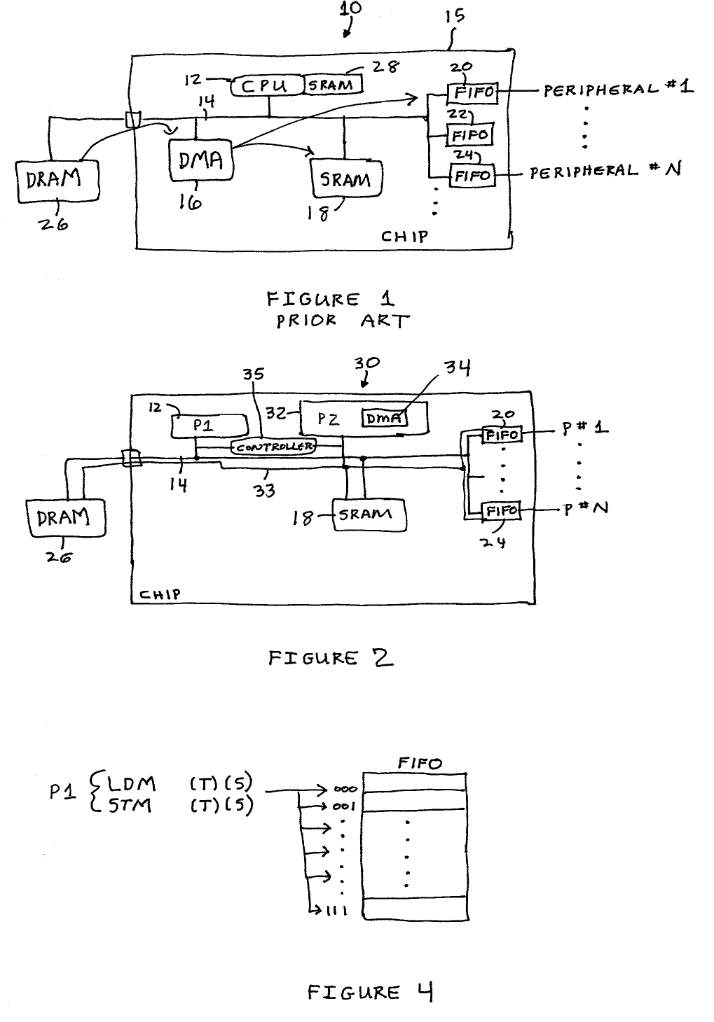

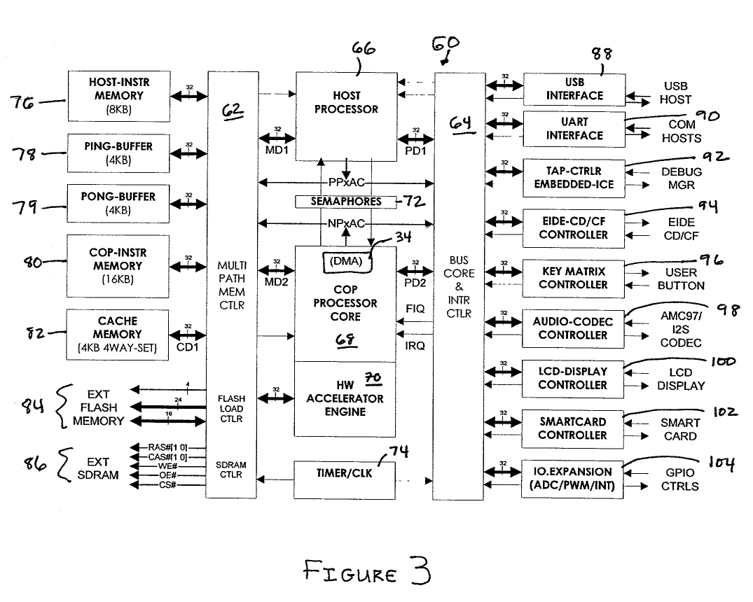

FIG. 4 is a diagram illustrating the operation of a preferred load multiple data and store multiple data instructions that may be used to implement the preferred embodiment of the software based DMA engine in accordance with the invention. In particular, a processor of the system may execute one or more instructions that implement that DMA operation. In a preferred embodiment, the emulated DMA scheme utilizes a processor to effectively transfer the data through the use of interrupt services, a load multiple data locations (LDM) instruction and a store multiple data locations (STM) instruction that may be present in the instruction set of the processors. In particular, the DMA emulation is through the use of the LDM/STM instruction since these are single instruction, multiple data (SIMD) instructions for moving consecutive memory contents into and out of consecutive register locations. In a preferred embodiment, the operands of the LDM and STM instructions are T and S as shown in FIG. 4 wherein T is the starting address of the target locations for storing or loading data and S is the starting address of the source locations for storing or loading data. To transfer data between the SRAM and one of the FIFO buffers shown in FIG. 2, the LDM instruction loads the data from consecutive locations in the FIFO buffer into an internal processor register and then a subsequent STM instruction stores the data from the internal processor registers into the SRAM consecutive memory locations. The LDM and STM instructions auto increment the address upon each move cycle so that the instruction overhead is minimized. In the preferred embodiment, the Hardware buffer FIFO should only qualify the upper address bits (A31:A8) and ignore the lower 8 bit addresses to accommodate LDM and STM's automatically incrementing addresses. In other word, each FIFO will have 256 alias locations such that any 256 addresses would hit the same FIFO.

The overhead of the DMA emulation in accordance with the invention may be further reduced by grouping the DMA services with other DMA tasks to minimize the number of register save and restore operations. Upon entering the DMA service routine, the STM should be used to Push all Register Contents prior to the FIFO data transfer. Before existing the DMA service routine, the LDM should be used to Pop all previous Register Contents. Now, an example of the pseudocode used for an audio DMA emulation in accordance with the invention will be described.

The pseudocode for the audio DMA emulation (with comments) may be:

Boot: JMP ColdBoot;

IRQ: JMP ISR;

FIQ:;CHECK for Interrupt Source and Branch to appropriate services

DMA:;CHECK for DMA Source and Branch to appropriate services

DMA_AUD_O:

PUSH {R0-R12} ; Save all Register contents

LDR R8,(PLY_BUFF) ; Get Audio Play Buffer Pointer

LDMIA R8!,{R0-R7} ; Bring 8W from Audio Output Buffer (from Memory)

STMIA AUD_PLY_FIFO!, {R0-R7} ;Send 8W to Audio Output FIFO (to CTLR)

STR R8,(PLY_BUFF) ; Save Audio Play Buffer Pointer

POP {R0-R12} ; Restore previous Register contents

RET

DMA_AUD_I:

PUSH {R0-R12} ; Save all Register contents

LDR R8,(REC_BUFF) ; Get Audio Record Buffer Pointer

LDMIA AUD_REC_FIFO!, {R0-R7} ; Get 8W from Audio Input FIFO (fin CTLR)

STMIA R8!,{R0-R7} ; Put 8W to Audio Input Buffer (to Memory)

STR R8,(REC_BUFF) ; Save Audio Record Buffer Pointer

POP {R0-R12} ; Restore previous Register contents

RET

While the foregoing has been with reference to a particular embodiment of the invention, it will be appreciated by those skilled in the art that changes in this embodiment may be made without departing from the principles and spirit of the invention, the scope of which is defined by the appended claims.

1. A computer system, comprising:
a first processor;
a second processor; and
a direct memory access (DMA) engine capable of being executed by one of the first and second processors, the DMA engine capable of transferring data between one or more resources in the computer system.

2. The system of claim 1, wherein the direct memory access engine further comprises one or more instructions being executed by one of the first and second processors that transfer data between the resources.

3. The system of claim 2, wherein the resources comprise one or more of static random access memory, dynamic random access memory and one or more hardware buffers that are capable of interfacing with one or more peripheral devices.

4. The system of claim 3, wherein the one or more hardware buffers, in combination with the DMA engine, permit the one or more peripherals to access the memory directly.

5. The system of claim 3, wherein the instructions further comprise a store multiple data instruction and a load multiple data instruction wherein the load multiple data instruction loads data from multiple locations in one of the hardware buffers into multiple locations in the internal registers in the processor executing the DMA engine instructions and wherein the store multiple data instruction transfers the data from multiple locations in the internal registers into multiple locations in a memory.

6. A computer implemented direct memory access apparatus that operates in a computer system having two or more processors, the apparatus comprising:
a load multiple data instruction capable of being executed by a processor in the computer system for loading data from multiple locations in a resource into multiple locations in an internal register in the processor; and
a store multiple data instruction capable of being executed by the processor in the computer system for storing data from multiple locations in the internal registers in the processor into multiple locations in a memory.

7. The apparatus of claim 6, wherein the resources comprise one or more of static random access memory, dynamic random access memory and one or more hardware buffers that are capable of interfacing with one or more peripheral devices.

8. The apparatus of claim 7, wherein the one or more hardware buffers, in combination with the DMA engine, permit the one or more peripherals to access the memory directly.

9. The apparatus of claim 8, wherein the instructions further comprise a store multiple data instruction and a load multiple data instruction wherein the load multiple data instruction loads data from multiple locations in one of the hardware buffers into multiple locations in the internal registers in the processor executing the DMA engine instructions and wherein the store multiple data instruction transfers the data from multiple locations in the internal registers into multiple locations in a memory.

10. A computer implemented direct memory access apparatus that operates in a computer system having two or more processors, the apparatus comprising:
a load multiple data instruction capable of being executed by a processor in the computer system for loading data from multiple locations in a resource into multiple locations in an internal register in the processor; and
a store multiple data instruction capable of being executed by the processor in the computer system for storing data from multiple locations in the internal registers in the processor into multiple locations in a memory; and
a data buffer FIFO capable of accepting multiple data transfers to and from any of its alias addresses.
